(19) United States
(12) Patent Application Publication
(10) Pub. No.: US 2005/0276292 A1
(43) Pub. Date: Dec. 15, 2005

(54) Circuit arrangement for operating a laser diode

(76) Inventor: Karl Schrodinger, Berlin (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 10/856,068

(22) Filed: May 28, 2004

(51) Int. Cl. H01S 3/00

(52) U.S. Cl. 372/38.02

(57) ABSTRACT

The invention relates to a circuit arrangement for operating a laser diode, having: a laser driver, to which a differential input signal is applied and which provides a differential output signal comprising a first output signal and a second output signal that is the inverse of the first output signal, which are provided at a first and a second laser driver output; a first laser diode, which is connected to the first laser driver output and to which the first output signal is applied; and a second laser diode, which is connected to the second laser driver output and to which the second output signal is applied. In this case, the load provided at the first laser driver output and the load provided at the second laser driver output are essentially identical. This has the effect that the supply current of the laser driver is essentially constant and, therefore, a high-frequency interference signal that effects an interference emission is not applied to said supply current. Only the light of a laser diode is utilized for information transmission.

The invention relates to a circuit arrangement for operating a laser diode. In particular, the invention relates to a circuit arrangement having a differential laser driver which makes it possible to suppress electromagnetic interference emission during operation of a laser diode.

### BACKGROUND OF THE INVENTION

It is known, in the context of electrical transmission or within electrical circuits, for a data signal which is to be transmitted to be transmitted differentially. In the case of a differential transmission, two mutually inverse signals are present. This has the advantage that components of a system can be driven differentially, i.e. these components respectively evaluate the difference between two mutually inverse input signals. Since the signals are the inverse of one another, twice the amplitude can be evaluated in this case. This reduces the system's susceptibility to interference and increases the stability.

In optical systems which operate with differential signals, the laser driver is also of differential design, i.e. a differential driving is effected at two input terminals by means of mutually inverse input signals. Such a differential laser driver provides a differential output signal, i.e. two mutually inverse output signals are present at two output terminals.

In the case of a customary single-ended driving of a laser diode, however, only one of said output signals is used as a driver signal for the laser diode. This is illustrated schematically in FIG. 2.

At a laser driver 1, a differential input signal comprising two mutually inverse signals S, −S is present at two input terminals 1E1, 1E2. The laser driver 1 provides two driver signals I_{T}, −I_{T} at two output terminals 1A1, 1A2. One of said output signals I_{T} provides a current through a laser diode 2, which generates a modulated light signal in accordance with the modulation of said current I_{T}. The output signal −I_{T} at the other driver output 1A2 is not utilized for data transmission and is fed to a complex impedance XD illustrated schematically. This is disadvantageously accompanied by the generation of interference radiation (EMI—Electro-Magnetic-Interference). The interference radiation is generated by fluctuations in the supply current of the laser driver on account of the unequal loads (XD, Laser) at the output of the laser driver.

The present invention is based on the object of providing a circuit arrangement for operating a laser diode which suppresses the production of electro-magnetic interference radiation as effectively as possible.

### SUMMARY OF THE INVENTION

The invention provides a circuit arrangement for operating a laser diode, having: a laser driver, to which a differential input signal is applied and which provides a differential output signal comprising a first output signal and a second output signal that is the inverse of the first output signal, which are provided at a first and a second laser driver output; a first laser diode, which is connected to the first laser driver output and to which the first output signal is applied; and a second laser diode, which is connected to the second laser driver output and to which the second output signal is applied. In this case, the load provided at the first laser driver output and the load provided at the second laser driver output are essentially identical.

The circuit arrangement according to the invention has the effect that the supply current of the laser driver, which (in the model) results from the sum of the output signals provided at the two laser driver outputs, is essentially constant. The constancy of the supply current results from the fact that the signals provided at the two outputs of the laser driver are the inverse of one another and—since they operate on the same load—are furthermore identical in terms of magnitude. On account of the constancy of the supply current, a high-frequency interference current component that would lead to an undesirable interference emission is not superposed on said supply current. Rather, the generation of interference emission is reduced and ideally completely suppressed.

The solution according to the invention is thus based on the concept of providing identical loads at the two differential outputs of a fully differential laser driver. The instances of interference caused by the two output signals at the two differential outputs compensate for one another, so that there is no interference amplitude on the supply current of the differential laser driver. Interference amplitudes on the supply current also generate, on account of unavoidable lead inductances, instances of interference on the supply voltage that in turn amplify the interference emission.

In a preferred refinement, only the light of one laser diode is utilized for data transmission and for this purpose coupled into an optical waveguide. The light of the second laser diode is preferably covered by a light-opaque material or a screen. The second laser diode is a “dummy diode” that, for reasons of circuit symmetry, is not used for data transmission and light generation.

The differential laser driver provides two mutually inverse pulse sequences at the first laser driver output and at the second laser driver output. The sum of the two currents provided at the two laser driver outputs is essentially constant over time. This results, on the one hand, from the inverse ratio of the two pulse sequences and, on the other hand, from the fact that both pulse sequences are respectively applied to the same load.

In order to realize an identical load, the two laser diodes preferably have structurally identical design. Preferably, the two laser diodes are in this case monolithically integrated into a common laser chip. Furthermore, the two laser diodes are preferably situated at a small distance from one another in order that temperature fluctuations and other changes in the operating conditions affect the two laser diodes in the same way. For this purpose, the two laser diodes are preferably spaced apart from one another at a distance of between 20 μm and 100 μm, in particular at a distance of approximately 50 μm, and are arranged on a common substrate or monolithically integrated into such a substrate.

### BRIEF DESCRIPTION OF THE DRAWINGS

The invention is explained in more detail below using an exemplary embodiment with reference to the figures, in which:

FIG. 1 shows a circuit arrangement having a differential laser driver, the differential output signal of which is fed to two structurally identical laser diodes arranged adjacently;

FIG. 2 shows a circuit arrangement having a laser driver and a laser diode in accordance with the prior art;

FIG. 3 shows an equivalent circuit diagram of the laser driver and the laser diode of the circuit arrangement in accordance with FIG. 2;

FIG. 4 shows an equivalent circuit diagram of the laser driver and the laser diodes of the circuit arrangement in accordance with FIG. 1;

FIG. 5A shows the supply current of the laser driver in accordance with FIG. 3;

FIG. 5B shows the current signals provided at the two outputs of the laser driver of FIG. 3;

FIG. 6A shows the supply current of the laser driver in accordance with FIG. 4; and

FIG. 6B shows the current signals provided at the two outputs of the laser driver of FIG. 4.

### DESCRIPTION OF A PREFERRED EXEMPLARY EMBODIMENT

A circuit arrangement for operating a laser diode in accordance with the prior art has been explained in the introduction with reference to FIG. 2.

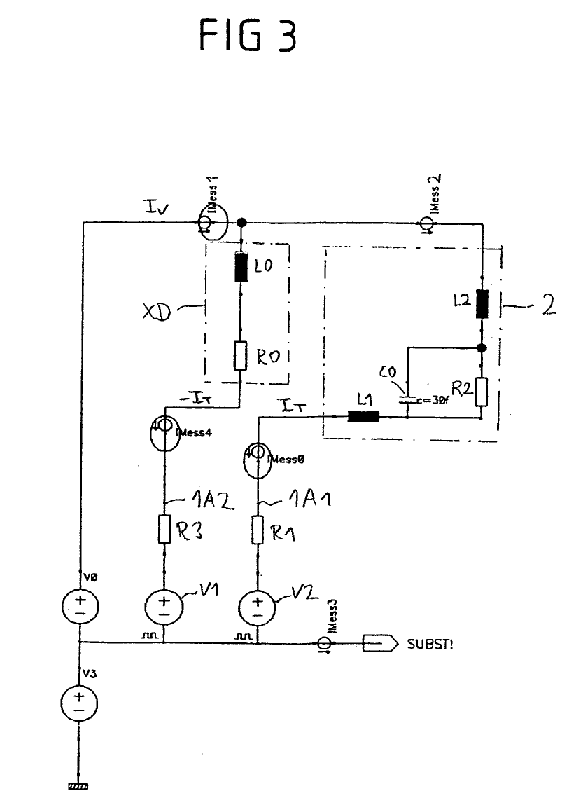

FIG. 3 shows an equivalent circuit diagram of such a known circuit arrangement. This diagram is supplementarily discussed in order to explain the disadvantages of the prior art. In the equivalent circuit diagram of FIG. 3, the laser driver 1 of FIG. 2 is formed by two pulse sources V1, V2 and two source resistances R1, R3. Mutually inverse output current signals I_{T}, −I_{T} are respectively provided at two output terminals 1A1, 1A2. In the equivalent circuit diagram of FIG. 3, the laser 2 is formed by two inductances L1, L2, a capacitance C0 and also a non-reactive resistance R2. In this case, the bonding wires of the laser diodes are modelled by the two inductances L1, L2. The current I_{T} provided at the output terminal 1A1 of the laser driver is applied to the laser diode 2.

The inverse current signal −I_{T} provided at the other output terminal 1A2 is fed to a complex impedance XD, which is formed by an internal termination resistance R0 and an inductance L0 in the equivalent circuit diagram. The inductance L0 is not equal to the inductance L1 plus L2 of the other branch of the circuit. On account of unavoidable fluctuations and temperature responses of the circuit and also of the laser diode, the internal resistance R0 is normally not equal to the internal resistance R2 of the laser diode 2.

The complex impedance XD may additionally also have capacitive elements that are likewise normally not equal to the capacitance of the laser.

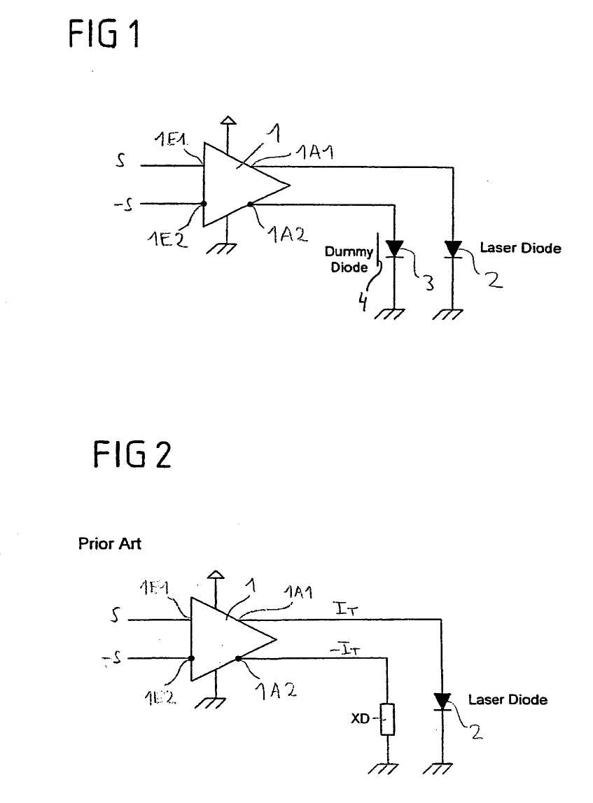

FIG. 1 shows a circuit arrangement in accordance with the present invention. Unlike in the circuit arrangement of FIG. 2, the signal −I_{T} provided at the second output 1A2 is fed to a further photodiode 3, which is covered by a screen or a light-opaque material 3 (illustrated schematically) and serves as a dummy diode.

The two diodes 2, 3 are preferably of structurally identical design and are arranged on a common laser chip at a relatively small distance, in particular at a distance of between 20 μm and 100 μm. The laser diodes are preferably vertically emitting diodes (VCSEL).

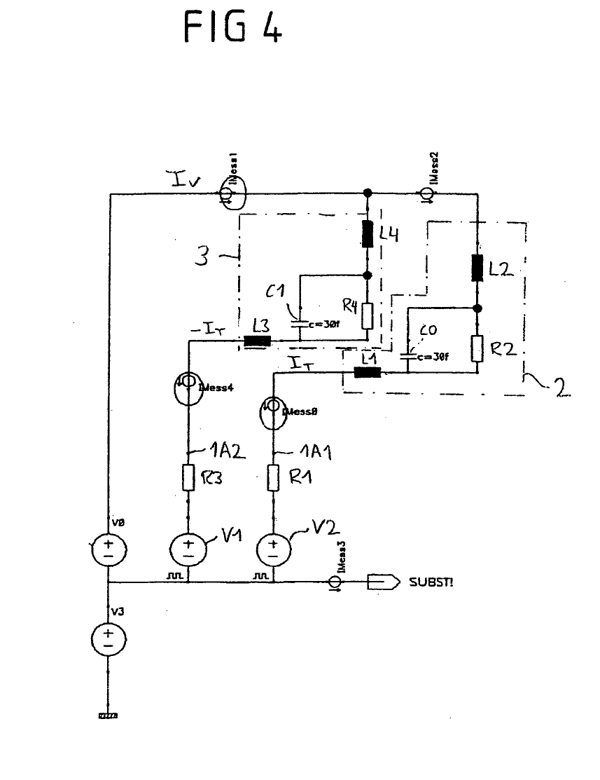

FIG. 4 shows an equivalent circuit diagram of the circuit in accordance with FIG. 1. In contrast to the circuit of FIG. 3, the further laser diode 3, the dummy laser diode, is provided instead of the complex impedance XD. In the equivalent circuit diagram, said diode is formed by two inductances L3, L4, a capacitance C1 and a nonreactive resistance R4. In this case, the bonding wires are once again modelled by the inductances L3, L4.

It is essential in this context that the loads provided by the two laser diodes 2, 3 and the bonding wires or other electrical contact connections in the two circuit branches are identical. It thus holds true that
L3+L4=L1+L2 (1)
C1=CO and (2)
R4=R2. (3)

The loads at the two differential outputs 1A1, 1A2 of the fully differential laser driver are thus identical.

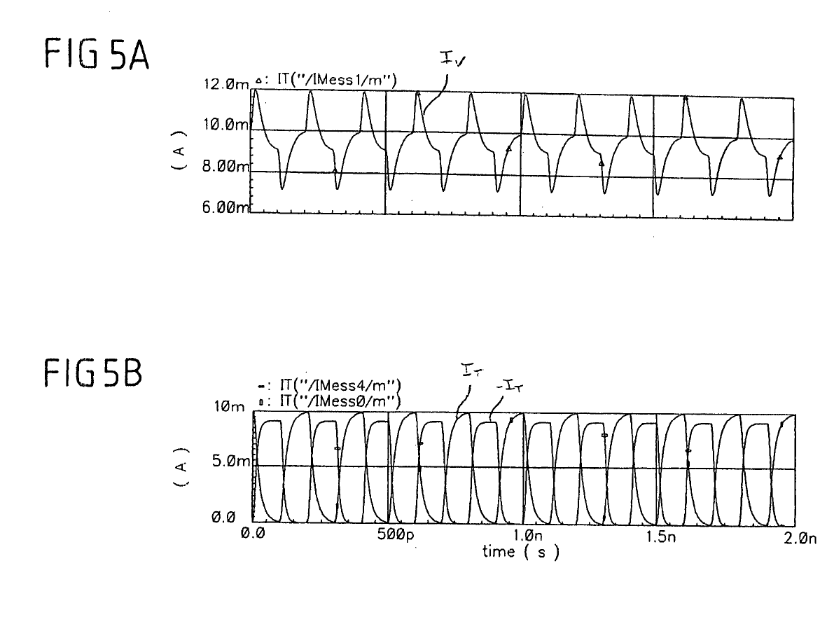

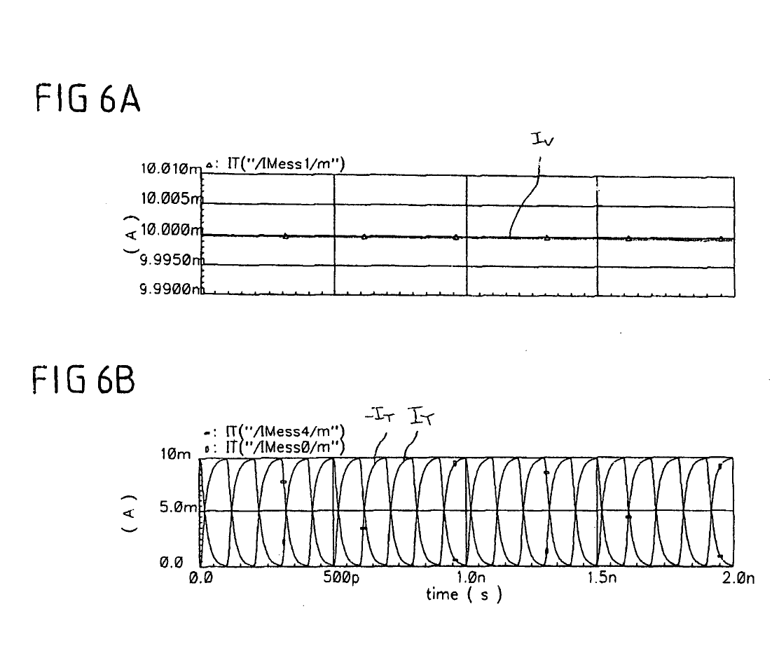

The advantages of this solution in comparison with the solution of the prior art in accordance with FIGS. 2 and 3 are explained with reference to FIGS. 5A to 6B.

FIG. 5B shows the simulation of the currents I_{T}, −I_{T} at the measurement nodes IMess0 and Imess4 of the equivalent circuit diagram of FIG. 3. It can be discerned that both the current rise times and the current amplitudes of the currents I_{T}, −I_{T} are different, the former owing to the different capacitive and inductive loads, the latter owing to the different resistive load. FIG. 5A shows the supply current Iᵥ of the laser driver at the measurement node Imess1 of FIG. 3. This supply current Iᵥ is equal to the sum of the currents at the two output terminals, 1A1, 1A2. It can be discerned that the supply current Iᵥ has a DC current component representing the actual supply current. An interference current component of approximately 4 mApk is superposed on said DC current component of approximately 10 mA. This corresponds to approximately 40% of the modulation amplitude. The interference current component flows via the supply voltage. Instances of interference in the current on the supply voltage are difficult to control, and generate undesirable electromagnetic emissions since they are difficult to suppress and on account of their high frequency. As already mentioned, instances of interference on the supply voltage, which in turn amplify the interference emission, are also induced on account of unavoidable lead inductances.

FIGS. 6A, 6B show the corresponding currents in a simulation of the circuit arrangement of FIG. 4. On account of the identical loads, the mutually inverse current signals provided at the two output terminals 1A1, 1A2 are completely the inverse of one another. Both the current rise times and the current amplitude are identical, apart from the inverse profile. The currents I_{T}, −I_{T} in FIG. 6B are in turn determined at the measurement locations Imess0, Imess4 of FIG. 4.

The inverse relationship, the identical profile and the identical amplitude of the two signals provided at the two output terminals 1A1, 1A2 of the laser driver result in a complete constancy of the supply current Iᵥ illustrated in FIG. 6. In this case, FIG. 6a shows the supply current Iᵥ at the measurement node Imess1. The supply current is constant at 10 mA.

The simulation of the currents of the fully differential laser driver reveals that the instances of interference completely compensate for one another on account of the complete identity of the loads at the two differential outputs of the laser driver. There is no longer an interference amplitude on the supply current Iᵥ, as can be discerned in FIG. 6A. In real circuits, a 100% compensation will not be effected, but electromagnetic emissions will be considerably suppressed even in said real circuits. This is of great importance particularly in the case of high bit rate modulation of a laser diode in the GHz range.

The configuration of the invention is not restricted to the exemplary embodiments presented above. The person skilled in the art recognizes that numerous alternative embodiment variants exist which, despite their deviation from the exemplary embodiments described, make use of the teaching defined in the subsequent claims.

1. A circuit arrangement for operating a laser diode, comprising:
a laser driver, to which a differential input signal is applied and which provides a differential output signal comprising a first output signal and a second output signal that is the inverse of the first output signal, which are provided at a first and a second laser driver output,
a first laser diode connected to the first laser driver output and to which the first output signal is applied, and
a second laser diode connected to the second laser driver output and to which the second output signal is applied, wherein
a load provided at the first laser driver output by the first laser diode and a load provided at the second laser driver output by the second laser diode are substantially identical.

2. The arrangement according to claim 1, wherein only light of the first laser diode is utilized for data transmission.

3. The arrangement according to claim 2, wherein the second laser diode is covered by a light-opaque material.

4. The arrangement according to claim 1, wherein the laser driver is configured to provide two mutually inverse pulse sequences at the first laser driver output and at the second laser driver output.

5. The arrangement according to claim 1, wherein a sum of the two currents associated with the first and second output signals provided at the two laser driver outputs is substantially constant over time.

6. The arrangement according to claim 1, wherein the first laser diode and the second laser diode are structurally identical.

7. The arrangement according to claim 1, wherein the first laser diode and the second laser diode are monolithically integrated into a common laser chip.

8. The arrangement according to claim 7, wherein the first laser diode and the second laser diode designed as comprise vertically emitting laser diodes.

9. The arrangement according to claim 7, wherein the first laser diode and the second laser diode are arranged on the common laser chip at a distance of between 20 μm and 100 μm.

10. A circuit arrangement for operating a laser diode, comprising:
a laser driver circuit configured to receive a differential input signal and generate a differential output signal in response thereto at a differential output, wherein the differential output signal comprises a first output signal and a second output signal that is the inverse of the first output signal;
a first laser diode connected to a first laser driver output of the differential output, and configured to receive the first output signal; and
a second laser diode connected to a second laser driver output of the differential output, and configured to receive the second output signal,
wherein a loading associated with the first laser diode at the first laser driver output and a loading associated with the second laser diode at the second laser driver output are substantially identical.

11. The arrangement of claim 10, wherein data associated with the second laser diode is not employed for data transmission.

12. The arrangement of claim 10, further comprising an opaque material covering at least a portion of the second laser diode, thereby preventing light associated therewith from being employed in data transmission.

13. The arrangement of claim 10, wherein the first and second laser diodes are driven by currents from the laser driver, and wherein a sum of the currents from the laser driver is substantially constant over time.

14. The arrangement of claim 13, wherein the sum of the currents is substantially constant due to the loading of the first and second laser diodes being substantially identical.
